(19) United States
(12) Patent Application Publication
(10) Pub. No.: US 2026/0002595 A1
(43) Pub. Date: Jan. 1, 2026

(54) VALVE DIAPHRAGM COMPRISING A SPRING ELEMENT, AND DIAPHRAGM VALVE

(71) Applicant: GEMÜ Gebr. Müller Apparatebau GmbH & Co. Kommanditgesellschaft, Ingelfingen (DE)

(72) Inventors: Michael Klemt, Pfedelbach (DE); Steffen Meinikheim, Ingelfingen (DE)

(21) Appl. No.: 19/247,417

(22) Filed: Jun. 24, 2025

(30) Foreign Application Priority Data
Jun. 26, 2024 (DE) 10 2024 118 040.4

(51) Int. Cl. F16K 7/16

(52) U.S. Cl. CPC F16K 7/16

(57) ABSTRACT

A valve diaphragm for a diaphragm valve includes a diaphragm layer having a clamping section and a functional section surrounded by the clamping section. The functional section is displaceable along an actuation axis. At least one elastic force transmission element is disposed on or within the clamping section and is structurally separate from the diaphragm layer. The force transmission element is configured to clamp the valve diaphragm against a valve body of the diaphragm valve.

### TECHNICAL FIELD

This disclosure relates to diaphragm valves and components thereof, and more particularly to valve diaphragms for use in diaphragm valve assemblies.

### BACKGROUND

Diaphragm valves are commonly used to regulate fluid flow in systems where factors such as cleanliness, flow accuracy, or resistance to corrosion are important. Typical applications include semiconductor manufacturing, pharmaceutical processing, and food and beverage production.

### SUMMARY

The present disclosure provides a valve diaphragm for a diaphragm valve, which is configured for fixation in the diaphragm valve.

In one aspect, a valve diaphragm is provided for a diaphragm valve. The valve diaphragm comprises: a wet-side diaphragm layer with a clamping section and a functional section surrounded by the clamping section, wherein the functional section is displaceable along an actuation axis; and at least one elastic force transmission element, arranged on or in the clamping section and formed separately from the diaphragm layer, for clamping the valve diaphragm against a valve body of the diaphragm valve.

By providing a force transmission element separate from the clamping section, a targeted and suitable clamping of the valve diaphragm on a valve body of the diaphragm valve can be achieved. The properties of the force transmission element, the clamping section, and the functional section can thereby be adjusted to the requirements of the diaphragm valve.

A spring rate of the force transmission element is greater than a spring rate of the diaphragm layer. An E-modulus of the force transmission element is larger than an E-modulus of the diaphragm layer.

Unless otherwise specified, numerical ranges and ratio expressions used herein are intended to include the stated endpoints and all intermediate values. For example, a range from 1.1:1 to 100,000:1 includes 1.1:1, 100,000:1, and all values in between.

The ratio between the spring rate of the elastic force transmission element and the diaphragm layer lies in a range between, and inclusive of, 100,000:1 and 1.1:1, and can be provided in a range between, and inclusive of, 10,000:1 and 1.5:1, or in aspects of this disclosure, in a range between, and inclusive of, 1,000:1 and 2:1. The ratio between the modulus of elasticity of the elastic force transmission element and the diaphragm layer lies in a range between, and inclusive of, 500:1 and 1.1:1, and can be in a range between, and inclusive of, 200:1 and 1.5:1, or in some aspects of this disclosure, can be in a range between, and inclusive of 50:1 and 2:1.

The at least one force transmission element can apply a preload to the valve diaphragm parallel to the actuation axis or can exert a spring force on the valve diaphragm parallel to the actuation axis. In some aspects of the disclosure, the valve diaphragm, for instance, the clamping section, is fixed against a valve body of the diaphragm valve.

In aspects of this disclosure, the spring seat and the at least one force transmission element are configured as complementary to one another, for instance, at least sectionally.

According to one aspect of this disclosure, the at least one force transmission element is configured as a wave spring, annular spring, or elastomer element, any of which can function as a simple force transmission element.

In one aspect of this disclosure, the at least one force transmission element is configured as annular and/or arranged along an imaginary first circle arranged around the actuation axis to facilitate homogeneous clamping of the clamping section along the circumference. In one aspect of this disclosure, a main direction of extension of the force transmission elements extends perpendicularly to the actuation axis.

In accordance with one aspect of the present disclosure, the diaphragm layer has a spring seat in the clamping section to facilitate precisely repeatable positioning of the force transmission element.

In accordance with some aspects of the present disclosure, the spring seat is configured as annular and/or arranged along an imaginary second circle arranged around the actuation axis to facilitate homogeneous clamping along the circumference. In certain aspects of this disclosure, the first and second circles are identical. The first circle and/or the second circle can be arranged perpendicular to the actuation axis.

In accordance with one aspect of the present disclosure, the spring seat can be accessible parallel to the actuation axis to facilitate easy accessibility and mounting. Furthermore, this makes the force transmission element replaceable.

In accordance with some aspects of the present disclosure, the spring seat can be accessible perpendicularly to the actuation axis, for instance, radially from the outside in relation to the actuation axis to facilitate easy accessibility and mounting. Furthermore, this makes the force transmission element replaceable. The spring seat can also be accessible from a direction parallel and/or perpendicular to the actuation axis.

The force transmission element can be preloaded towards the actuation axis. The force transmission element has an inner diameter that is smaller than an outer diameter of the spring seat. In this configuration, the force transmission element can be immovably fixed to the clamping section without requiring any additional fastening structure.

The spring seat can be L-shaped, pot-shaped, or U-shaped. The force transmission element and the spring seat are configured to correspond to each other, at least sectionally.

In accordance with one aspect of the present disclosure, the at least one force transmission element can be supported against a dry side of the diaphragm layer.

In accordance with some aspects of the present disclosure, the valve diaphragm, for instance, the clamping section, has a dry-side diaphragm layer, wherein the at least one force transmission element is supported against a contact side, facing the dry side of the wet-side diaphragm layer, of the dry-side diaphragm layer. The force transmission element can be arranged between the wet-side diaphragm layer and the dry-side diaphragm layer.

In accordance with one aspect of the present disclosure, a plurality of force transmission elements can be provided that are arranged parallel to the actuation axis. In aspects of this disclosure, a main direction of extension of the force transmission elements extends parallel to the actuation axis.

In accordance with one aspect of the present disclosure, at least one force transmission element can be made of spring steel, chrome-vanadium steel, chrome-silicon steel, nickel alloys, polyether ether ketone, nylon, or polyurethane. In this configuration, the force transmission element can be configured to meet low compression set and/or high durability requirements in the region of the clamping section.

In accordance with one aspect of the present disclosure, a modulus of elasticity of the at least one force transmission element perpendicular to a valve body-side clamping surface of the clamping section of the diaphragm layer and/or parallel to the actuation axis can be at least twice as large. In some aspects of the present disclosure, such modulus of elasticity can be least five times as large, at least ten times as large, or in certain aspects, at least twenty times as large, as a modulus of elasticity of the main material of the at least one clamping section of the diaphragm layer to facilitate strong clamping. The modulus of elasticity can be evaluated in a direction perpendicular to the clamping surface as defined herein, or in parallel with the actuation axis.

According to one aspect of this disclosure, a diaphragm valve with a valve body, with a drive body, and with a valve diaphragm is provided, wherein at least one force transmission element of the valve diaphragm is arranged between the valve body and the drive body for clamping the valve diaphragm against the valve body.

### BRIEF DESCRIPTION OF THE DRAWINGS

Further advantages and aspects of this disclosure emerge from the claims and from the following description of preferred exemplary embodiments of this disclosure, which are explained below with reference to the figures. Identical and functionally corresponding elements are provided with identical reference signs. In the drawings:

FIG. 1 is a sectional view of a diaphragm valve;

FIG. 2 is a top view of a valve diaphragm for use in the diaphragm valve according to FIG. 1;

FIG. 3 is a top view of another valve diaphragm for use in the diaphragm valve according to FIG. 2; and

FIG. 4A-E are sectional views of embodiments of spring seats and force transmission elements.

### DETAILED DESCRIPTION

In certain diaphragm valve applications, maintaining a stable seal over time can be challenging due to material settling, thermal cycling, or fluctuating clamping pressures. Conventional diaphragm valves may experience reduced sealing effectiveness or require complex fastening systems to ensure long-term fixation of the diaphragm. The present disclosure addresses this technical problem by providing a valve diaphragm with a separately formed elastic force transmission element. This element is configured to apply a spring force that maintains clamping pressure between the diaphragm and the valve body, thereby enhancing sealing reliability, simplifying installation, and compensating for material relaxation or dimensional shifts during operation.

Unless otherwise expressly indicated, the following terms have the meanings provided below. These definitions are intended to clarify, not limit, the scope of the claims.

As used herein, “clamping section” refers to a peripheral portion of the diaphragm layer that is securable between opposing structural components of the diaphragm valve, such as a valve body and a drive housing. The clamping section provides a sealing interface and helps maintain the position of the diaphragm within the valve assembly.

As used herein, “functional section” refers to a portion of the diaphragm layer that is surrounded by the clamping section and is displaceable along an actuation axis. The functional section is operable to regulate fluid flow by opening or closing a flow path within the diaphragm valve.

As used herein, “actuation axis” refers to a directional axis along which the functional section of the diaphragm moves during valve actuation. This axis is typically aligned with a linear motion imparted by a drive mechanism or actuator, and extends perpendicular to the plane of the diaphragm layer.

As used herein, “clastic force transmission element” refers to a component that is formed separately from the diaphragm layer and is disposed on or within the clamping section. The force transmission element is made from a spring material or elastomeric material and is configured to apply a preload or spring force to the diaphragm, thereby enhancing sealing or positional fixation relative to a valve body.

As used herein, “spring seat” refers to a feature of the diaphragm layer, such as a groove, recess, cavity, or pocket, that is configured to receive and support an elastic force transmission element. The spring seat can be formed integrally within a single diaphragm layer or between stacked diaphragm layers, and can be accessible along an axial or radial direction.

As used herein, “wet-side diaphragm layer” refers to the portion of the diaphragm that is exposed to the process fluid flowing through the diaphragm valve. This layer can be formed from materials selected for chemical compatibility, elasticity, or resistance to fluid-induced wear.

As used herein, “dry-side diaphragm layer” refers to the portion of the diaphragm oriented away from the fluid side and typically facing the actuator, drive housing, or spring element. The dry-side layer can serve structural or retention functions and can form part of a multilayer diaphragm assembly.

As used herein, “clamping surface” refers to the surface of the diaphragm layer that is positioned to engage a mating surface of a valve body or housing in a compressed state. The clamping surface is typically oriented perpendicular to the actuation axis and contributes to scaling when the valve is assembled.

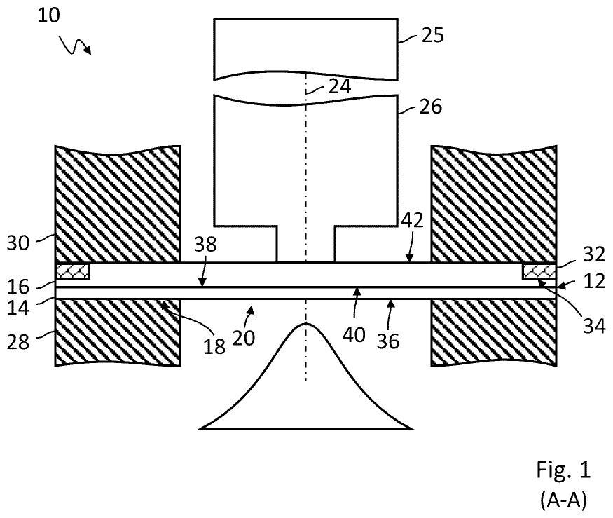

According to FIG. 1, the diaphragm valve 10 has a valve diaphragm 12 with a wet-side diaphragm layer 14 and a dry-side diaphragm layer 16. The valve diaphragm 12 comprises a clamping section 18 and a functional section 20 surrounded by the clamping section 18. The functional section 20 can be displaced along an actuation axis 24 between an open position facing away from the through-line 22 and a closed position facing the through-line 22 by a drive 25 and the drive rod 26 in order to open and close a through-line 22 of the diaphragm valve 10.

The valve diaphragm 12 is clamped and fixed between a valve body 28 of the diaphragm valve 10 and a drive housing 30 or between an intermediate housing. The fixing of the valve diaphragm 12 in the region of the clamping section 18 serves to seal the through-line 22 towards the drive housing 30. Due to settling phenomena of the diaphragm material and the resulting reduced clamping of the valve diaphragm 12, at least one force transmission element 32 is additionally arranged in a spring seat 34 of the valve diaphragm 12.

In order to facilitate sealing in the region of the clamping section 18, a first wet side 36 can be subjected to a spring force against the valve body 28. For this purpose, the at least one force transmission element 32 and the spring seat 34 can be arranged on a first dry side 38 of the wet-side diaphragm layer 14, and/or between the wet-side diaphragm layer 14 and the dry-side diaphragm layer 16, and/or on a second wet side 40 of the dry-side diaphragm layer 16, and/or on a second dry side 42 of the dry-side diaphragm layer 16. Alternatively, in some aspects of this disclosure, the wet-side diaphragm layer 14 and/or the dry-side diaphragm layer 16 be formed in multiple layers at least in the region of the at least one force transmission element 32, wherein the at least one force transmission element 32 is arranged between the multiple layers of the wet-side diaphragm layer 14 and/or dry-side diaphragm layer 16.

According to FIG. 1, the dry-side diaphragm layer 16 has a force transmission element 32. For this purpose, the dry-side diaphragm layer 16 comprises a spring seat 34 which is accessible parallel to the actuation axis 24 and, in relation to the actuation axis 24, radially from the outside. The force transmission element 32 is supported on the one hand against the drive housing 30 and on the other against the dry-side diaphragm layer 16, such that the wet-side diaphragm layer 14 is pressed against the valve body 28.

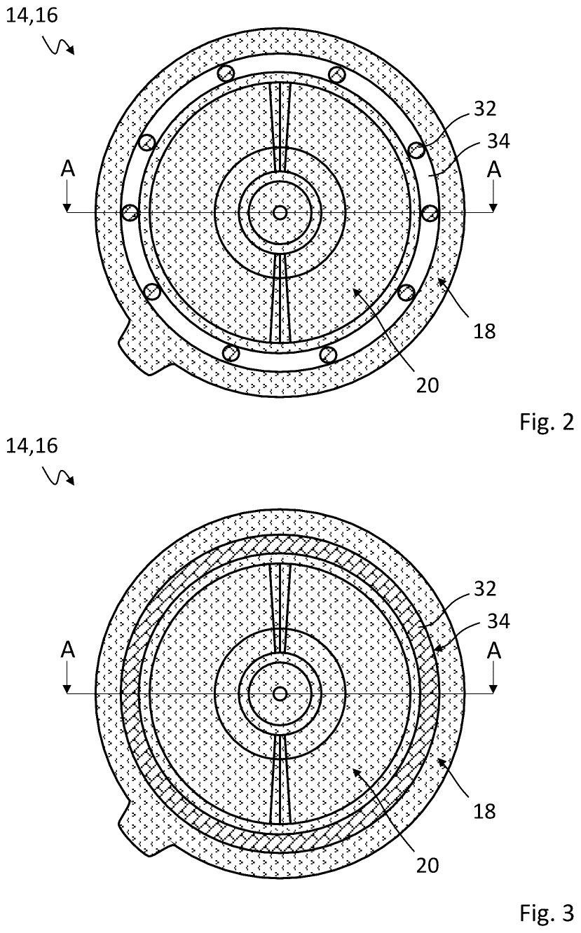

According to FIG. 2, ten force transmission elements 32 are arranged along an imaginary circle around the actuation axis 24 on or in the valve diaphragm 12, such as on or in the wet-side diaphragm layer 14 and/or on or in the dry-side diaphragm layer 16. The main direction of extension of the force transmission elements 32 can run parallel to the actuation axis 24. Accordingly, the force transmission elements 32 exert a spring force parallel to their main directions of extension.

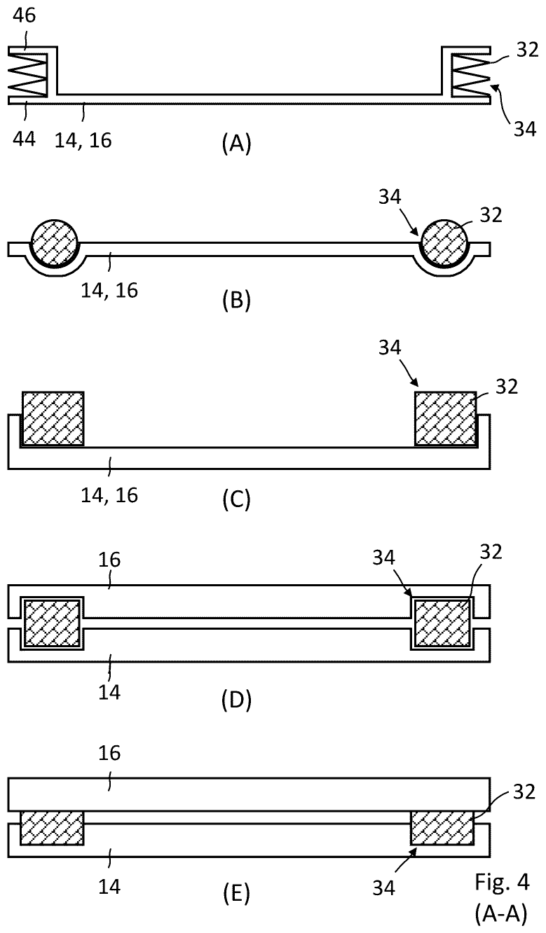

For accommodating the force transmission elements 32, the valve diaphragm 12 has an annular spring seat 34, wherein the annular spring seat 34 also extends along the imaginary circle. The spring seat 34 in FIG. 2 can be pot-shaped with a seat base, a seat inner side, and a seat outer side, and limits the force transmission elements 32 downwards, radially outwards, and radially inwards. The spring seat 34 can be accessible parallel to the actuation axis 24 from the first dry side 38 or second dry side 42. A corresponding design of the spring seat 34 is shown in FIG. 4E in the first dry side 38 of the wet-side diaphragm layer 14. For each force transmission element 32, a separate spring seat 34 can be provided.

According to FIG. 3, a cohesive force transmission element 32 is provided which in its main direction of extension extends along the imaginary circle. This configuration enables the force transmission elements 32 to exert a spring force perpendicular to their main directions of extension. The spring seat 34 can be designed as in FIG. 2.

FIG. 4A-E show different embodiments of how the force transmission elements 32 and the spring seats 34 of the valve diaphragms 12 can be designed. The shown diaphragm layers can represent both the wet-side diaphragm layer 14 as well as the dry-side diaphragm layer 16. In order to simplify the description of FIG. 4A-C, reference is made below only to the wet-side diaphragm layer 14, even though this can also be applied to the dry-side diaphragm layer.

According to FIG. 4A, the wet-side diaphragm layer 14 is formed in multiple layers, at least in the region of the clamping section 18. The wet-side diaphragm layer 14 in the region of the clamping section 18 comprises a primary layer 44, facing the through-line 22, and a secondary layer 46, facing away from the through-line 22. The wet-side diaphragm layer 14 has a spring seat 34 which is accessible radially from the outside in relation to the actuation axis 24. The spring seat 34 can be on the radially outer side of the valve diaphragm 12 in relation to the actuation axis 24. The spring seat 34 can be pot-shaped, wherein, in contrast to FIGS. 2 and 3, it is rotated outwards by 90°. The primary layer 44 and the secondary layer 46 form the seat inner side and outer side of the spring seat 34. The force transmission elements 32 are designed here, for example, as compression springs extending parallel to the actuation axis 24. Alternatively, it is also conceivable that a plurality of elastomer elements or a wave spring or a ring spring be used. Accordingly, it can be seen that the spring seats 34 are designed to accommodate different force transmission elements 32. The accessibility also allows the force transmission elements 32 to be easily replaced.

According to FIG. 4B, the wet-side diaphragm layer 14 has a recess, with a semicircular cross-section, as a spring seat 34. Alternatively, the recess can be elliptical. The spring seat 34 can be arranged in the clamping section 18. The spring seat 34 can be continuous along the circumference of the valve diaphragm 12 and can extend along the imaginary circle. In some aspects of the present disclosure, a single force transmission element 32 is provided, wherein it also extends along the imaginary circle corresponding to the spring seat 34 and is formed continuously along the circumference of the valve diaphragm 12. Here, too, the spring seat 34 can be arranged in the region of the outside, the inside, or in the middle region of the clamping section 18. Since the spring seat 34 is accessible parallel to the actuation axis 24, from the first wet side 36 of the diaphragm layer, the force transmission element 32 can be mounted on the wet-side diaphragm layer 14 by a joining movement parallel to the actuation axis 24.

According to FIG. 4C, the wet-side diaphragm layer 14 has an L-shaped spring seat 34. The spring seat 34 can be parallel to the actuation axis 24 and accessible radially from the inside in relation to the actuation axis 24. Compared to FIG. 1, the L-shaped spring seat 34 is here mirrored. An annular elastomer element can be used as the force transmission element 32. The force transmission element 32 and the spring seat 34 are can be configured such that the outer side of the force transmission element 32 rests against the seat inner side of the spring seat 34. These can further be designed with such dimensions that the force transmission element 32 preloads the valve diaphragm 12 radially outwards.

According to FIG. 4D, the wet-side diaphragm layer 14 and the dry-side diaphragm layer 16 each have two opposing, pot-shaped, spring seats 34. The spring seats 34 can be on the one hand on the first dry side 38 of the wet-side diaphragm layer 14, and on the other on the second wet side 40 of the dry-side diaphragm layer 16. For example, in the mounted state, the force transmission element 32 engages in both diaphragm layers. In another example, a single, annular elastomer element can be used. Alternatively, wave or ring springs can be provided.

The valve diaphragm 12 according to FIG. 4E differs from that in FIG. 4D in that only one spring seat 34 is provided. This can be arranged on the first dry side 38 of the wet-side diaphragm layer 14, as shown in FIG. 4E, or on the second wet side 40 of the dry-side diaphragm layer 16, or on the second dry side 42 of the dry-side diaphragm layer 16. According to FIG. 4E, the force transmission element 32 in the mounted state comes into contact with the flat, second wet side 40 of the dry-side diaphragm layer 16. For example, single, annular elastomer element can be used. Alternatively, wave or ring springs are also conceivable.

It should be noted that the size ratios of the diaphragm layers 14, 16, the force transmission elements 32, the spring seats 34, and the gap dimensions may be depicted distorted in the figures for simplified illustration.

The valve diaphragm described in this disclosure offers several technical benefits. By integrating an elastic force transmission element separately from the diaphragm layers, the design enables tailored mechanical properties and long-term clamping force retention. The replaceability and accessible mounting of the force transmission element also improve serviceability and manufacturing flexibility. Additionally, the spring seat configurations (ranging from annular to pot-shaped or L-shaped) support various installation geometries and force directions, enhancing adaptability to different valve body and drive housing arrangements. These design features can collectively contribute to improved sealing performance, reduced risk of leakage, and extended service life in demanding fluid control applications.

### LIST OF REFERENCE SIGNS

10 Diaphragm valve
12 Valve diaphragm
14 Wet-side diaphragm layer
16 Dry-side diaphragm layer
18 Clamping section
20 Functional section
22 Through-line
24 Actuation axis
25 Drive
26 Drive rod
28 Valve body
30 Drive housing
32 Force transmission element
34 Spring seat
36 First wet side of the wet-side diaphragm layer
38 First dry side of the wet-side diaphragm layer
40 Second wet side of the dry-side diaphragm layer
42 Second dry side of the dry-side diaphragm layer
44 Primary layer
46 Secondary layer

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

Persons skilled in the art will understand that the structures and methods specifically described herein and shown in the accompanying figures are non-limiting exemplary aspects, and that the description, disclosure, and figures should be construed merely as exemplary of aspects. It is to be understood, therefore, that the present disclosure is not limited to the precise aspects described, and that various other changes and modifications can be effected by one skilled in the art without departing from the scope or spirit of the disclosure.

Additionally, the elements and features shown or described in connection with certain aspects can be combined with the elements and features of certain other aspects without departing from the scope of the present disclosure, and that such modifications and variations are also included within the scope of the present disclosure. Accordingly, the subject matter of the present disclosure is not limited by what has been particularly shown and described.

What is claimed:

1. A valve diaphragm for a diaphragm valve, the valve diaphragm comprising:
a diaphragm layer including a clamping section and a functional section surrounded by the clamping section, the functional section being displaceable along an actuation axis; and
at least one elastic force transmission element disposed on or within the clamping section and formed separately from the diaphragm layer, the at least one force transmission element being configured to clamp the valve diaphragm against a valve body of the diaphragm valve.

2. The valve diaphragm of claim 1, wherein a spring rate of the force transmission element is greater than a spring rate of the diaphragm layer, and/or a modulus of elasticity of the force transmission element is greater than a modulus of elasticity of the diaphragm layer.

3. The valve diaphragm of claim 2, wherein a ratio between the spring rate of the force transmission element and the spring rate of the diaphragm layer is in the range from 1.1:1 to 100,000:1, and/or wherein a ratio between the modulus of elasticity of the force transmission element and the modulus of elasticity of the diaphragm layer is in the range from 1.1:1 to 500:1.

4. The valve diaphragm of claim 1, wherein the force transmission element is disposed on a wet-side diaphragm layer or a dry-side diaphragm layer.

5. The valve diaphragm of claim 1, wherein the force transmission element comprises a wave spring, annular spring, compression spring, or elastomer element.

6. The valve diaphragm of claim 1, wherein the force transmission element is annular or is arranged along an imaginary circle around the actuation axis.

7. The valve diaphragm of claim 1, wherein the diaphragm layer includes a spring seat in the clamping section.

8. The valve diaphragm of claim 7, wherein the spring seat is annular or is arranged along an imaginary circle around the actuation axis.

9. The valve diaphragm of claim 8, wherein the spring seat is accessible parallel to the actuation axis.

10. The valve diaphragm of claim 9, wherein the spring seat is accessible perpendicular to the actuation axis.

11. The valve diaphragm of claim 10, wherein the spring seat is L-shaped, pot-shaped, or U-shaped.

12. The valve diaphragm of claim 1, wherein the force transmission element is supported against a dry side of the diaphragm layer.

13. The valve diaphragm of claim 12, wherein the diaphragm layer includes a dry-side diaphragm layer, and the force transmission element is supported against a surface of the dry-side diaphragm layer that faces a dry side of a wet-side diaphragm layer.

14. The valve diaphragm of claim 1, further comprising a plurality of force transmission elements arranged parallel to the actuation axis.

15. The valve diaphragm of claim 1, wherein the force transmission element comprises a material selected from the group consisting of spring steel, chromium-vanadium steel, chromium-silicon steel, nickel alloys, polyether ether ketone (PEEK), nylon, and polyurethane.

16. The valve diaphragm of claim 1, wherein a modulus of elasticity of the force transmission element, measured in a direction perpendicular to a clamping surface of the diaphragm layer, is at least twice, five times, ten times, or twenty times greater than a modulus of elasticity of a main material of the clamping section of the diaphragm layer.

17. A diaphragm valve comprising:
a valve body,
a drive housing, and
the valve diaphragm of claim 1, wherein the force transmission element is arranged between the valve body and the drive housing to clamp the valve diaphragm against the valve body.
